(19) United States
(12) Patent Application Publication
(10) Pub. No.: US 2002/0004786 A1
(43) Pub. Date: Jan. 10, 2002

(54) Information offering system

(75) Inventors: Motoyuki Tagawa, Tokyo (JP); Takeaki Nakamura, Tokyo (JP); Akio Nakada, Tokyo (JP); Norio Seki, Tokyo (JP); Seiji Kuramoto, Tokyo (JP); Naoki Mori, Tokyo (JP); Takao Tabata, Tokyo (JP); Yukiko Furukawa, Tokyo (JP)

Correspondence Address: SCULLY, SCOTT, MURPHY & PRESSER, 400 Garden City Plaza, Garden City, NY, 11530, US

(73) Assignee: OLYMPUS OPTICAL CO LTD, TOKYO (JP)

(21) Appl. No.: 09/886,797

(22) Filed: Jun. 21, 2001

(30) Foreign Application Priority Data
Jun. 21, 2000 (JP) 2000-186666

(51) Int. Cl. H04K 1/00; H04L 9/00; G06F 17/60

(52) U.S. Cl. 705/64

(57) ABSTRACT

An information offering method including: disclosing summary information about a designated product via a designated communication line; judging whether or not the user reading said summary information disclosed by said summary information disclosing step and desiring to read detailed product information about the product about which said summary information is disclosed is a user who is permitted to read detailed information; and disclosing detailed information about the product about which said summary information is disclosed, to the user who is judged to be permitted to read detailed information by said judgment step.

### BACKGROUND OF THE INVENTION

(1) Field of the Invention

The present invention relates generally to a system in which given information is offered to a user, and more particularly to an information offering system which can be used to offer information on medical instrument products to users.

(2) Description of the Related Art

Unlike the ordinary goods market, users and purchasers of medical instruments are limited to doctors and hospital employees in charge of procurement of such medical instruments.

Although in the case of ordinary goods, it may be possible to sell them to users by advertising them through general mass media, because of the limited users of medical instruments, such advertising activities are not cost-effective for the medical instrument market.

Therefore, traditional promotional practices have been used in the medical instrument market: such as displaying products at meetings of medical science societies, visiting hospitals for advertising products, publishing articles in medical science journals, advertising by telephone, or by direct mail.

Although in the case of some surgical instruments, it is necessary to show the same through dynamic picture images or demonstrations, for example, how the surgical instrument operates so that users may assess its effectiveness. However, such demonstrations cannot be made when it is advertised in articles of medical science journals or by direct mail. Therefore, the product advertising effect cannot be exhibited very well.

On the other hand, in the case of advertising by telephone, it is difficult in practice to get in contact with doctors by telephone because they have to consume much of each day in performing surgery or examining patients. Although demonstrations can be made during hospital visits, much time is required to visit a hospital and to prepare for a demonstration, which may increase sales costs.

Therefore, such expenses are reflected in the final product price, and in other words, may increase medical costs.

### SUMMARY OF THE INVENTION

The present invention made in consideration of the above is intended to provide an information offering system which allows to reduce sales expenses by improving the system for offering information to users.

Accordingly, an information offering system is provided. The information offering system comprises: a summary information disclosing means for disclosing summary information about a designated product via a designated communication line; a judgment means for judging whether or not the user reading said summary information disclosed by said summary information disclosing means and desiring to read detailed information about the product about which said summary information is disclosed is a user who is permitted to read detailed information; and a detailed information disclosing means for disclosing detailed information about the product about which said summary information is disclosed, to the user who is judged to be permitted to read detailed information by said judgment means.

Also provided is an information offering method. The method comprising: disclosing summary information about a designated product via a designated communication line; judging whether or not the user reading said summary information disclosed by said summary information disclosing step and desiring to read detailed product information about the product about which said summary information is disclosed is a user who is permitted to read detailed information; and disclosing detailed information about the product about which said summary information is disclosed, to the user who is judged to be permitted to read detailed information by said judgment step.

Still yet provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 is a schematic diagram showing a medical instrument sales system.

FIG. 2 is a block diagram showing the server configuration of the maker side system in FIG. 1.

FIG. 3 is an explanatory drawing of the user file database constructed in the data storage device in FIG. 2.

FIG. 4 is an explanatory drawing of the product file database constructed in the data storage device in FIG. 2.

FIG. 5 is a flow chart showing the user registration process by the maker-side system in FIG. 1.

FIG. 6 is a drawing showing the homepage opened by the maker-side system in FIG. 1.

FIG. 7 is a drawing showing the homepage for non-member users opened by the maker-side system in FIG. 1.

FIG. 8 is the member registration screen in the processing flow in FIG. 5.

FIG. 9 is a flow chart showing the process for updating files and offering product information to member users by the maker-side system in FIG. 1.

FIG. 10 is a flowchart showing the processing flow for extracting member users' mail addresses in FIG. 8.

FIG. 11 is a flow chart showing the processing flow only for member users in FIG. 9.

FIG. 12 is a flow chart showing the flow after receiving product information by the user system in FIG. 1.

FIG. 13 is a flow chart showing the processing flow for member users' requesting information on the homepage of the maker-side system in FIG. 1.

FIG. 14 is the added detailed information screen to be opened.

### DETAILED DESCRIPTION OF THE PREFERRED EMBODIMENTS

Although this invention is applicable to numerous and various types of information offering systems, it has been found particularly useful in the environment of medical instrument sales. Therefore, without limiting the applicability of the invention to medical instrument sales, the invention will be described in such environment.

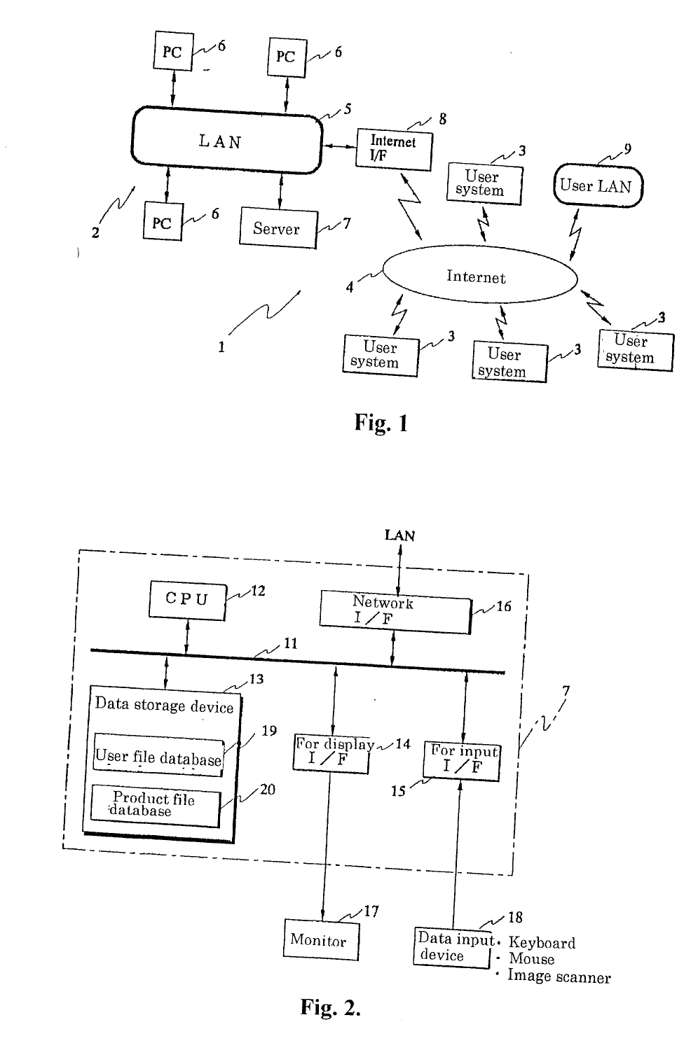

As shown in FIG. 1, a preferred medical instrument sales system 1 of the present invention is illustrated. The system 1 comprises a maker-side system 2 for selling medical instruments and plural user systems 3 (e.g., systems for hospitals that are purchasers of medical instruments) that are interconnected via a wide-area network, such as the Internet 4.

The maker-side system 2 comprises plural personal computers 6 (hereinafter referred to as “PCs”) and a server 7 connected to the local-area network 5 (hereinafter referred to as “LAN”), and an Internet interface device 8 (hereinafter referred to as “Internet I/F”) that allows LAN 5 to be connected to Internet 4. The maker-side system 2 can transmit and receive information to and from user systems 3 connected to Internet 4 via the Internet I/F 8. User LANs 9 constructed in the facilities of larger end users, such as hospitals or other facilities can be also connected to the maker-side system 2 via the Internet 4. Multiple PC's 6 are shown by way of example only and not to limit the spirit or scope of the present invention. Those skilled in the art will realize that the maker-side system may consist of a single PC 6 connected via the Internet 4 to the plural user systems 3.

As shown in FIG. 2, the above-mentioned server 7 comprises a CPU 12 connected to the bus 11, a data storage device 13, a display I/F 14, an input I/F 15, a network interface 16, and the like. The above-mentioned network I/F 16 is connected to LAN 5. The input I/F 15 is connected to a data input device 18 such as a keyboard and/or mouse, or an image scanner. The display I/F 14 is connected to the monitor 17.

In the data storage device 13, are constructed a user file database 19 managing user information and a product file database 20 managing product informnation. CPU 12 controls a variety of processes: constructing these databases, as well as controlling the display I/F 14, input I/F 15, and network I/F 16. In the situation where the maker-side system 2 consists of a single PC and not a LAN, the PC's CPU, storage device, interfaces, monitor, and data input devices provide the same function as the server 7.

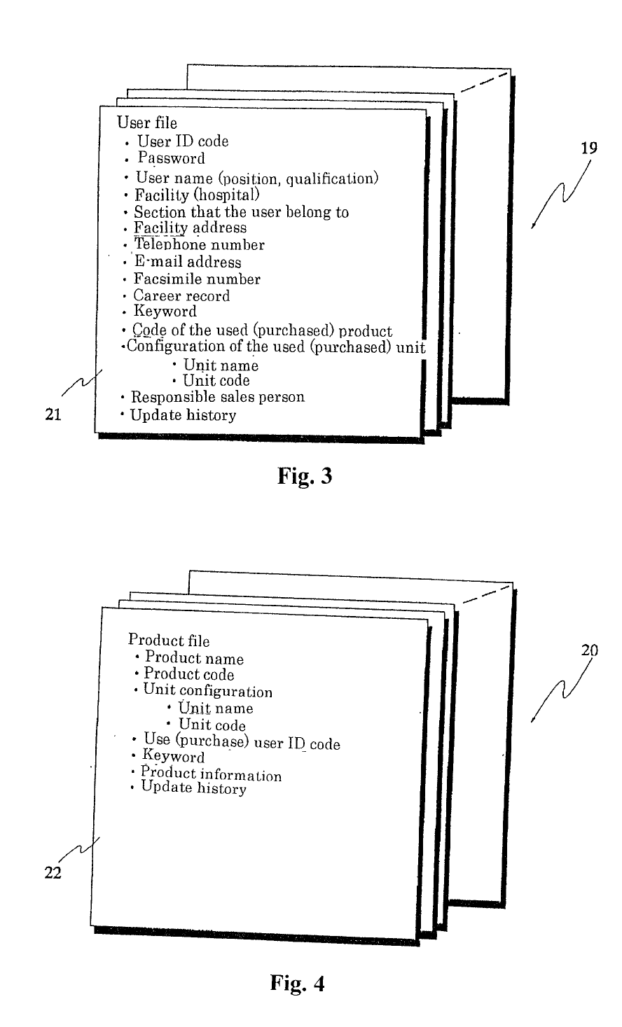

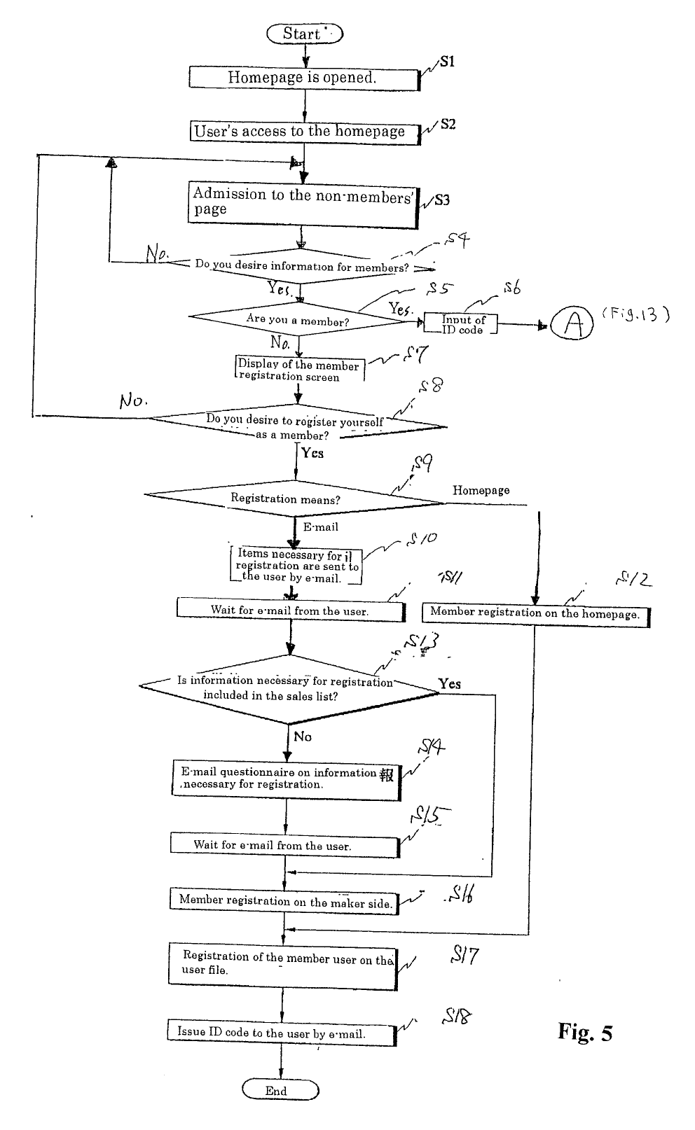

As shown in FIG. 3, the above-mentioned user file database 19 comprises plural user files 21. Preferably, on those user files 21, are recorded, for each user, the user ID code, password, user name (including the position name and the qualification information such as doctor or nurse), facility (hospital) name, section name, facility address, telephone number, e-mail address, facsimile number, career record, keywords (related information, for example, techniques that he or she is interested in), code of the used (purchased) product, configuration of the used (purchased) unit (unit name and unit code), name of the responsible sales person, file update history, and the like.

Among user data, user name (including the position name and the qualification information such as doctor or nurse), facility (hospital) name, section name, career record, keywords (related information, for example, techniques that he or she is interested in), and the like, are the user's own peculiar data.

As shown in FIG. 4, the product file database 20 comprises plural product files 22. Preferably, on those user files, are recorded, for each product, the product name, product code, configuration of the used (purchased) unit (unit name and unit code), use (or purchase) user ID code, field in which the product is used, keywords (related information, for example, techniques that he or she is interested in), product information, file update history, and the like.

Furthermore, the user file database 19 and the product file database 20 are preferably linked, such as through user ID codes or used (or purchased) product ID codes. In the case of user files 21, the used (purchased) product code, configuration of the used (purchased) unit (unit name and unit code), and the like are updated, for example, when a user purchases a product. In the case of user files 22, use (or purchase) user ID code, and the like are updated, and the update history for each is rewritten. All pieces of information in the user file database 19 and the user file 21 can be updated as necessary.

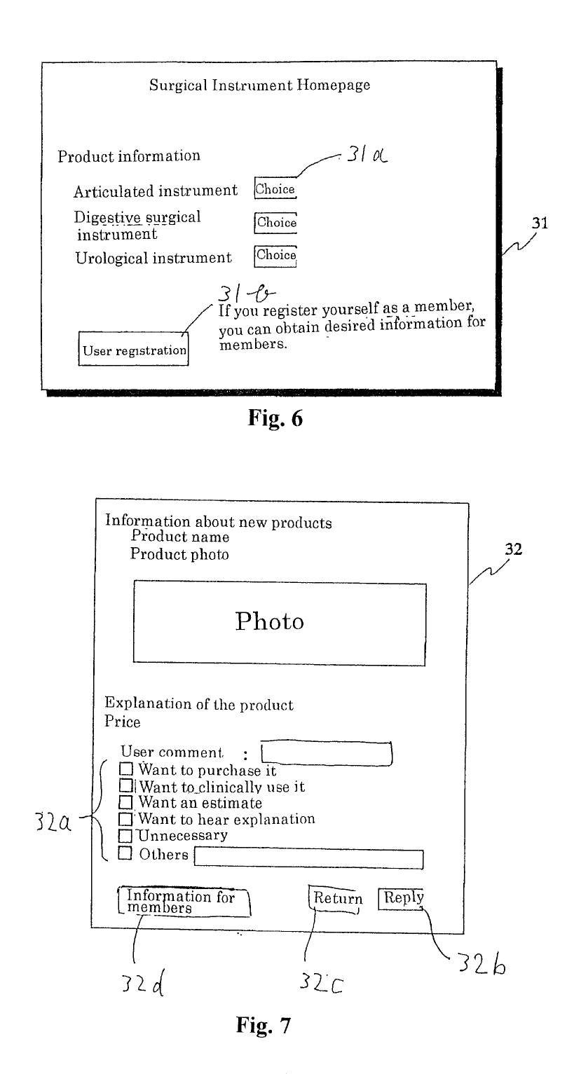

Next, using the processing flow chart shown in FIG. 5, how a user is registered as a member and how a user ID code is issued are described. First, in Step S1, the homepage 31, as shown in FIG. 6, prepared in the server 4 is opened on Internet 4 via the Internet I/F 8. Next, when a user accesses the homepage 31 in Step S2, he or she will be permitted only to access the non-member users' page 32, as shown in FIG. 7. For example, when the selection button 31 a for “Articulated Instruments” is pressed (clicked) among “Product Information” items displayed on the homepage 31 in FIG. 6, the non-member users' page 32 shown in FIG. 7 will be opened.

If the user desires to transmit his or her request or opinion on products to the maker while reading the non-member users' page 32 shown in FIG. 7, he or she should click one of the check boxes 32a in the non-member users' page 32 next to a corresponding request, or input a comment into the blank space of the box “Others,” and click the reply button 32b. This allows the user to transmit his request or opinion to the maker side. On the other hand, clicking the return button 32c returns the user to the homepage screen 31 shown in FIG. 6.

Next, returning to the flow chart shown in FIG. 5, in Step 4, it is determined whether the user desires more detailed product information for members. When the user takes interest in a product on the non-member users' page 32, or desires that more detailed information should be provided to read, he or she is required to become a member. In the next Step, whether the user is a member or not is confirmed. First, when the user clicks the members' information button 32d on the non-member users' page 32 shown in FIG. 7, whether his or her user ID code is registered or not will be determined in Step S5.

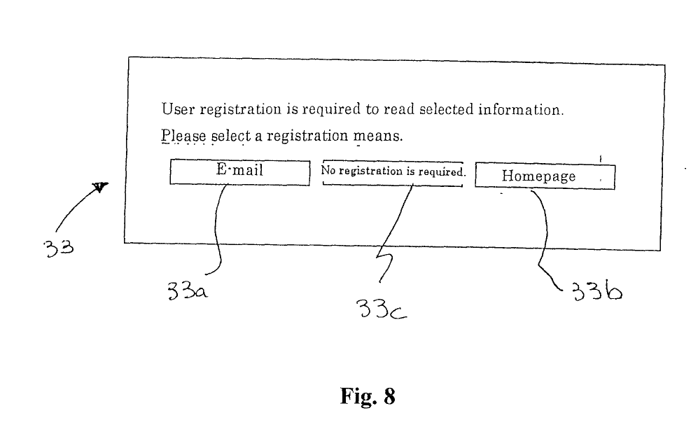

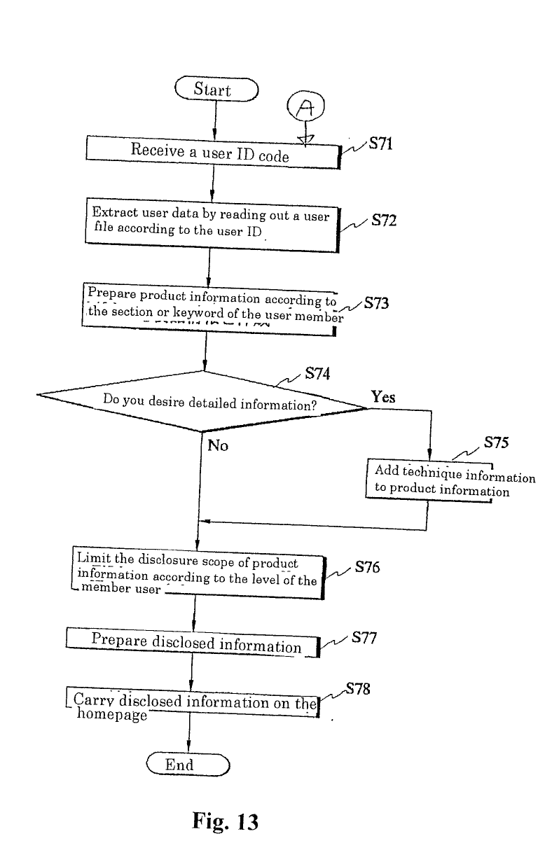

Alternatively, even when the user checks one of the check boxes 32a (“Want to purchase it,” “Want to clinically use it,” “Want to be explained,” etc.) on the non-member users' page 32, and presses the reply button 32b, whether his or her ID code is registered or not will be determined in Step S5. If his or her ID code is not registered, the member registration screen shown in FIG. 8 will be displayed instead of the screen 32 shown in FIG. 7 in Step S7. If the user ID code is registered in Step S5, his or her ID code will be input in Step S6 to jump to Step S71 shown in FIG. 13. This process is described below in detail. On the other hand, if the user does not desire to read members' information in the above-mentioned Step S4, the process for Step S3 will be continued.

Next, if the user desires to register himself or herself as a member in Step S8 on the member registration screen 33 in FIG. 8 displayed in Step S7, he or she must select a registration manner in Step S9. Preferably, the user must decide to register himself or herself by e-mail or on the homepage 31. If the user does not desire to register himself or herself, button 33c is clicked and the process continues back to Step S3. If “e-mail” is selected in Step 9 by clicking the e-mail button 33a, the maker will send an e-mail to the user to ask registration information (user data) necessary for the registration process in Step S10. What the maker asks the user about is necessary to construct the user file 19 shown in FIG. 3. When the user receives the e-mail from the maker, he or she must answer all the questions that the maker asks.

During this time period, the maker side waits for the user's reply in Step S11. After the e-mail from the user is received in Step S11, it is determined whether all pieces of registration information (user data) necessary for the sales list is provided. Here, this sales list includes the contents of lists prepared by salespersons for users having made contact with the maker via salespersons. Therefore, even those users who are not registered for the present system can be checked.

If registration information necessary for the sales list is insufficiently provided, required registration information will be asked of the user, for example, through an e-mail questionnaire in Step S14. An e-mail from the user is waited for again in Step S15. When an e-mail from the user is received in Step S15, and that all pieces of registration information (user data) necessary for the sales list is provided is judged in Step S13, the maker side will proceed to member registration in Step S15, using the data input device 18.

On the other hand, if the user select the “homepage” alternative by clicking the homepage button 33b in Step S9, he or she will move from the member registration screen shown 33 in FIG. 8 to a registration page on which the member registration process will be conducted in Step S12.

After the member registration process is conducted on the maker side in Step S16, or on the homepage in Step S12, the member user will be registered on the user file database in Step S12, and a user file is prepared. A user ID code is preferably given to this user file. Preferably, the user ID code is issued by e-mail to complete the member registration process. According to the flow chart shown in FIG. 5, the member registration process is started on the homepage 32 shown in FIG. 7. However, it is also possible to display the user registration button on the homepage 31 displayed in Step S2 shown in FIG. 5, and to jump from this page to the ID code registration process starting from Step S8. Completing the member registration process as shown above, the user can access members' pages by inputting his or her user ID code and password when accessing the homepage 31 (see FIG. 6), and obtain detailed information about products.

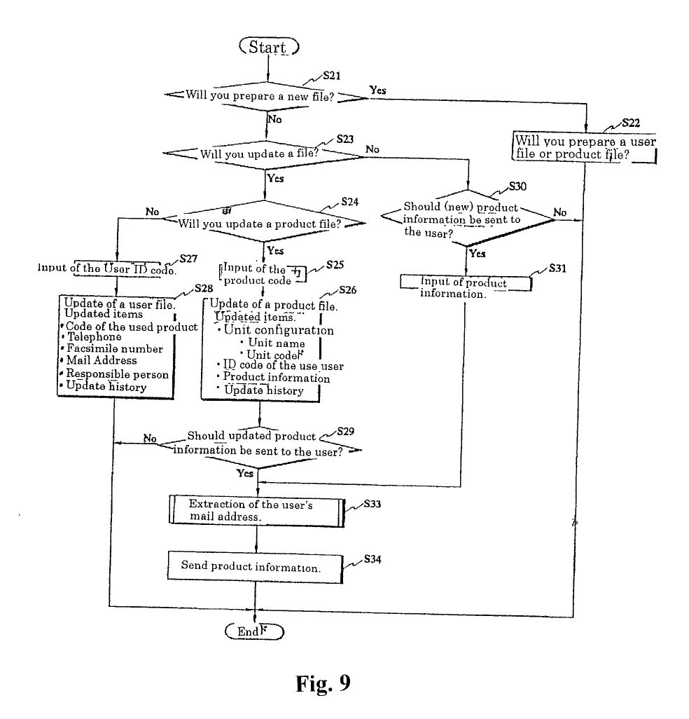

Next, how a user file 21 and product file 22 are updated, and how information about products is provided are described. First, as shown in FIG. 9, when a responsible person from the maker-side accesses the maker-side system 2, the maker-side system 2 will wait for an input for newly preparing a user file 21 or product file 22 in Step 21. If a file is newly prepared, the member registration process described in Step S11 in FIG. 5 is carried out on the user files 21 in Step S22. On the product files 22, a new file is prepared, and the file update process and the product information offering process for member users are completed. On the other hand, if no file is newly prepared in Step S21, an input will be waited for updating a user files 21 or product file 22 in Step S23.

If either file is updated, an input is waited for to judge whether a product file 22 should be updated or not in Step S24. If the file to be updated is a product file 22, the product code should be input in Step S25 to update a product file 22 in Step 26. On the other hand, if the file to be updated is not a product file, a user file 21 will be updated. For this, the user ID code is input in Step S27, the user file 21 is updated in Step S28, and the file update process and the product information offering process for the member user are completed. If a product file 22 is updated in Step S26, an input is waited for to judge whether updated product information should be sent to the member user by e-mail in Step S29. If no updated product information is sent in Step S29, the file update process and the product information offering process for member users are completed.

On the other hand, if updated product information is sent, Step S33 will be taken. If it is determined that no user file 21 nor product file 22 should be updated, Step S30 will be taken. In Step S30, an input is waited for to judge whether product information (for example, about new products) should be sent to member users by e-mail without updating any file. If no product information is sent in Step S30, the file update process and the product information offering process for member users are completed. If in Step S30, updated product information is sent, product information to be sent will be input in Step S31, and Step S33 will be taken. In Step S33, the member users' mail address extraction process as described below is carried out. And, in Step S34, detailed product information based on user information peculiar to member users is, by e-mail, sent to those member users whose mail addresses have been extracted in Step S33.

As described above, the file update process and the product information offering process for member users are completed. Detailed product information based on user information peculiar to member users is such information as prepared for each member user and based on one or more keywords consisting of the position information, qualification information (doctor, nurse, etc), and related information (facility or hospital name, section name, career record, interesting techniques, etc).

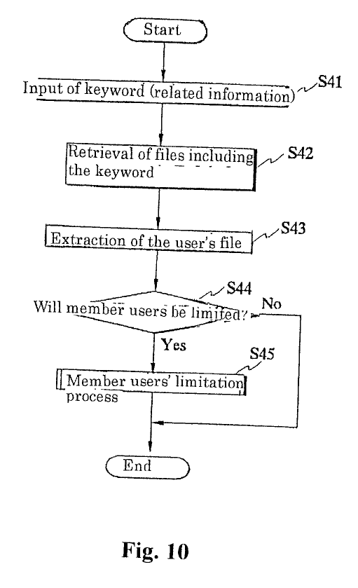

Next, the member users' mail address extraction process in the abovementioned Step S33 will be described using FIG. 10. First, if a keyword related to product information is input in Step S41, product files including the input keyword can be retrieved in Step S42. In the next Step S43, user files 21 are extracted using the user IDs included in retrieved product files. In the next Step S44, an input is waited for to judge whether member users to whom information is sent should be limited or not. If member users to whom information is sent are limited, the member users' limitation process as described below will be carried out in Step S45, and the member users' mail address extraction process will be completed. On the other hand, unless member users to whom information is sent are limited, the member users' mail address extraction process will be completed.

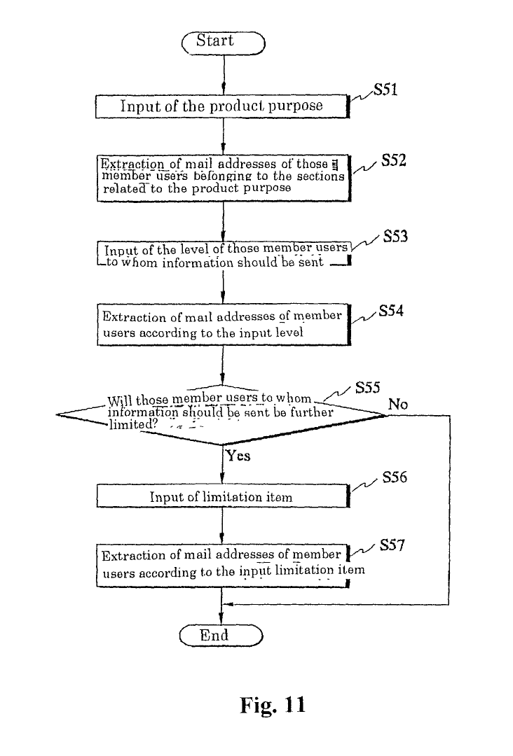

Next, the member users' limitation process in the above-mentioned Step S45 will be described in detail, using FIG. 11. First, in Step S51, the purposes for which the product is used are input. In the next Step S52, member users who belong to sections having the purposes input in Step S52 are taken, and their mail addresses are extracted. In Step S53, the levels (for example, doctor or nurse, or special member user who has participated in the product development) of those member users to whom information should be sent are input.

In the next Step S54, member users are narrowed down according to the levels input in Step S53, and their mail addresses are extracted again. In the next Step S55, an input is waited for to judge whether those member users to whom information should be sent should be further limited. If they are further limited, Step S56 will be taken to input limitation items for further narrowing down and limiting member users to whom information should be sent. Such limitation items consist of a variety of pieces of information including positions (professor, assistant professor, etc), career record, geographical region, etc. of those member users to whom information will be sent.

On the other hand, if they are not limited, the process is completed. In Step S56, if items are input to limit member users to whom information should be sent, member users are narrowed down according to the limitation items input in Step S57, and their mail addresses are extracted again.

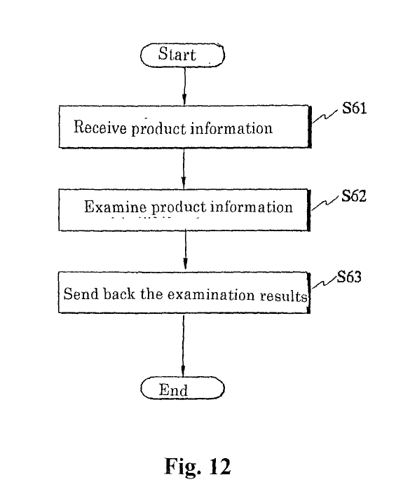

Thereafter, mail addresses of those member users to whom information should be sent are extracted, and product information based on specific user information will be sent, preferably by e-mail, to member users of those mail addresses extracted in Step S34 shown in FIG. 9. When a member user on the user system 3 receives such product information, he or she can examine such product information in Step S62 as shown in FIG. 12. When the member user sends back the examination results to the maker-side system 2 in the next Step S63, practical sales activities such as selling of products can start.

Here, how the request of a member user on the user system 3 for product information (for example, about new products) is processed on the maker-side system 2 will be described using FIG. 13. When the maker-side system receives a user ID code via the members' homepage on the homepage 31 in Step S71, a user file 21 will be read out based on the received user ID code, and user data will be extracted, in the next Step S72. In the next Step S73, product information is to be prepared according to the section that the member user belongs to, or related information (keyword) that he or she is interested in. Next, in Step S74, whether the member user desires to receive detailed information is read. If the member user desires to receive detailed information in this Step S74, technique information will be added to product information in Step S75, and Step S76 will be taken. On the other hand, if the member user does not desire to receive detailed information, Step S76 will be taken directly. In Step S76, the disclosure extent of product information is limited according to the level (for example, doctor or nurse) of the member user.

In the next Step S77, disclosed information is prepared according to the disclosed scope limited in Step S76. And, in Step S78, disclosed information prepared in Step S77 is carried on the homepage (members' page) in Step S77. This process provides member users with product information most suitable and satisfactory to him or her.

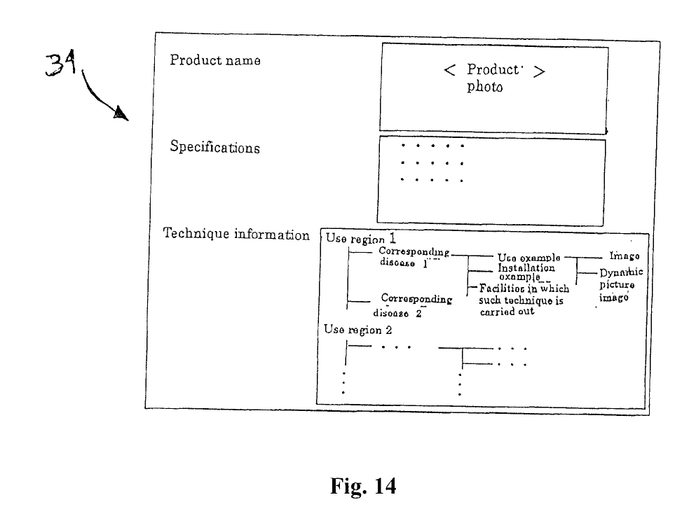

An example of the member users' detailed information screen 34 is shown in FIG. 14. On the member users' detailed information screen 34 in FIG. 14, are shown detailed photographs and detailed specifications of a product are disclosed, as well as for what techniques or diseases it is used, examples of its use (images, etc.), examples of unit installation, and examples of facilities in which it is used. Open information may be sent to member users by e-mail instead of being carried on the homepage (members' page).

According to the present embodiment, the most appropriate product information corresponding to the section, level, etc. can be provided for member users on the user system 3 via Internet 4. Therefore, not only the sales system and distribution route can be improved, but also expenses for business activities toward selling of products such as medical instruments can be reduced, and product costs can be prevented from increasing.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. An information offering system comprising:
a summary information disclosing means for disclosing summary information about a designated product via a designated communication line;
a judgment means for judging whether or not the user reading said summary information disclosed by said summary information disclosing means and desiring to read detailed information about the product about which said summary information is disclosed is a user who is permitted to read detailed information; and
a detailed information disclosing means for disclosing detailed information about the product about which said summary information is disclosed, to the user who is judged to be permitted to read detailed information by said judgment means.

2. An information offering system according to claim 1, further comprising an address obtaining means for obtaining the address on a communication line accessed by the user who desires to read detailed information about the product about which said summary information is disclosed.

3. An information offering system according to claim 2, further comprising an address inputting means for inputting said address obtained by said address obtaining means.

4. An information offering system according to claim 2, further comprising an address storing means for storing said address obtained by said address obtaining means.

5. An information offering system according to claim 1, further comprising a product information storing means for storing product information based on the summary information disclosed by said summary information disclosing means and the detailed information disclosed by said detailed information disclosing means.

6. An information offering system according to claim 1, further comprising a user data inputting means for inputting via a designated communication line specific user data accessed by the user who is permitted to read said summary information, and a detailed information editing means for editing detailed information disclosed by said detailed information disclosing means based on the user data inputted by said user data inputting means.

7. An information offering system according to claim 6, further comprising a user ID code issuing means for issuing a specific user ID code to the user owning the user data inputting by said user data inputting means.

8. An information offering system according to claim 7, further comprising a user data recording means for recording user data related with the user ID code issued by said user ID code issuing means.

9. An information offering system according to claim 7, further comprising a user ID code/product information relating means for relating summary information disclosed by said summary information disclosing means and product information based on the detailed information disclosed by said detailed information disclosing means with the user ID code issued by said user ID code issuing means.

10. An information offering method comprising:
disclosing summary information about a designated product via a designated communication line;
judging whether or not the user reading said summary information disclosed by said summary information disclosing step and desiring to read detailed product information about the product about which said summary information is disclosed is a user who is permitted to read detailed information; and
disclosing detailed information about the product about which said summary information is disclosed, to the user who is judged to be permitted to read detailed information by said judgment step.

11. An information offering method according to claim 10, further comprising obtaining an address on a communication line accessed by the user who desires to read said detailed product information about the product about which said summary information is disclosed.

12. An information offering method according to claim 11, further comprising inputting said address.

13. An information offering method according to claim 11, further comprising storing said address obtained by said address obtaining step.

14. An information offering method according to claim 10, further comprising storing said detailed product information based on the summary information and the detailed product information.

15. An information offering method according to claim 10, further comprising inputting via a designated communication line specific user data accessed by the user who is permitted to read said summary informnation, and editing said detailed product information based on the input specific user data.

16. An information offering method according to claim 15, further comprising issuing a specific user ID code to the user owning the input specific user data.

17. An information offering method according to claim 16, further recording user data related with the issued user ID code.

18. An information offering method according to claim 16, further comprising relating said summary information and said detailed product information based on the detailed product information with the issued user ID code.

19. A program storage device readable by machine, tangibly embodying a program of instructions executable by the machine to perform method steps for information offering, the method comprising:
disclosing summary information about a designated product via a designated communication line;
judging whether or not the user reading said summary information disclosed by said summary information disclosing step and desiring to read detailed product information about the product about which said summary information is disclosed is a user who is permitted to read detailed information; and
disclosing detailed information about the product about which said summary information is disclosed, to the user who is judged to be permitted to read detailed information by said judgment step.

20. A computer program product embodied in a computer-readable medium for an information offering, the computer program product comprising:
20. computer readable program code means for disclosing summary information about a designated product via a designated communication line;
computer readable program code means for judging whether or not the user reading said summary information disclosed by said summary information disclosing step and desiring to read detailed product information about the product about which said summary information is disclosed is a user who is permitted to read detailed information; and
computer readable program code means for disclosing detailed information about the product about which said summary information is disclosed, to the user who is judged to be permitted to read detailed information by said judgment step.
